(19) United States
(12) Patent Application Publication
(10) Pub. No.: US 2018/0186028 A1
(43) Pub. Date: Jul. 5, 2018

(54) ADJUSTABLE DOOR HINGE AND DOOR JAMB TEMPLATE

(71) Applicant: Felix Ponce, Reseda, CA (US)

(72) Inventor: Felix Ponce, Reseda, CA (US)

(21) Appl. No.: 15/394,543

(22) Filed: Dec. 29, 2016

(51) Int. Cl. B27F 5/12; B25H 7/02

(52) U.S. Cl. CPC B27F 5/12; B25H 7/02

(57) ABSTRACT

A universal door hinge template assembly for use with a tool for fabricating a mortise in a door or door jamb for a hinge includes a plurality of template modules including at least two end modules with one or more intermediate modules, where each template module comprises: a base having an aperture defined therein to guide the tool for forming the mortise, the aperture having two pairs of opposing sides; a pair of opposing adjustable hinge templates having a selected shape and selectively positioned at one of the pairs of opposing sides of the aperture; and a plurality of connecting bars of selective length which are selectively fixed between each two adjacent template modules in the assembly.

### BACKGROUND

### Field of the Technology

The invention relates to the field of door fittings, namely relating to hinges for doors, windows or wings, such as templates for fitting of the same in International class, E05D 11/00.

### Description of the Prior Art

Hanging a door n hinges within a door frame is a precise task that is prone to error. When done properly, the door fits snugly within the door frame when closed, with well-defined gaps around all four edge surfaces of the door. Further, when done properly, the door swings open freely on the hinges, and may stay open at any intermediate position between fully closed and fully open (assuming no other constraints are in place). In short, the door will be level, balanced, well-positioned, and secure. In practice, it may be difficult for either professional or amateur woodworkers to achieve these results, particularly in a repeatable or reliable manner. For example, if a woodworker attempts to position the hinges by measuring associated distances, then the smallest error measurement may cause an undesirable and noticeable offset when hanging the door. Even if one door is hung well, the process of doing so may be lengthy and difficult, and the woodworker may nevertheless have to seek to repeat the process (e.g., when installing multiple doors in a house, so that the different doors appear uniform with one another).

Consequently, door hinge templates have been developed that seek to provide woodworkers with fast, easy, reliable techniques for hanging doors in door frames. Generally, door hinge templates are used to guide a cutting instrument, e.g., a router, to form a recess (also known as a mortise) for a hinge in an edge surface of a door and in the facing surface of a door frame. That is, such door hinge templates may be used to form a first mortise in the surface of the door frame, and a second mortise in the facing edge surface of the door,so that first and second hinge portions, respectively, may fit there into. In this way, the door may be hung within the door frame in a desired fashion. Door hinge templates are designed to ensure that the first and second mortises are aligned with one another n a manner that ensures that surfaces of the door and door frame that face each other are substantially coplanar with one another, in both vertical and horizontal directions. Moreover, the door hinge templates should also ensure that the door and door frame are flush with one another when the door is closed. In short, the door hinge template is designed to ensure that doors may be hung within door frames in a manner that is precise, straight-forward, and repeatable, and that minimizes reliance on human alignment, estimation, or measurement.

However, there is a wide variety of door and door jamb heights and widths. In addition, the number of hinges may be two, three or more depending on the size and weight of the door. As a result, a plurality of hinge templates must be provided for a corresponding plurality of different configurations. Finish carpenters are thus required to purchase and retain a plurality of templates in order to be able to install doors of various configurations with consequent cost multiplication and tool inventory burdens. What is needed is a design for a hinge template that can be adjusted for all configurations using a single hinge template.

### BRIEF SUMMARY

The illustrated embodiment of the invention includes a kit for a universal door hinge template assembly for use with a tool for fabricating a mortise in a door or door jamb for a hinge. The kit includes a plurality of template modules including at least two end modules with possibly one or more included intermediate modules, where each template module comprises: a base having an aperture defined therein to guide the tool for forming the mortise, the aperture having two pairs of opposing sides: a pair of opposing adjustable hinge templates having a selected shape and selectively positioned at one of the pairs of opposing sides of the aperture. The end modules comprise an adjustable door thickness guide and a nail retained in the base for temporarily fixing the module to the door or door jamb. A plurality of connecting bars of selective length are selectively fixed between each two adjacent template modules in the assembly.

The plurality of connecting bars are providing with varying lengths to allow user selection in configuring the universal door hinge template assembly to be usable with a plurality of door and door jamb sizes and number of hinges to be fitted therein.

Each the pair of hinge templates is reversible to provide a guide for two different shaped hinges.

A plurality of hinge templates are provided each with a guide corresponding to a plurality of different hinge shapes.

The door has an edge into which the mortise is defined and the adjustable door thickness guide comprises a selectively positionable guide pin corresponding to a plurality of door thicknesses, the guide pin for positioning the end module and its corresponding aperture relative to the door edge.

The adjustable door thickness guide further comprises a rotatable disk pivoted to the base of the end module and where the guide pin is coupled to the rotatable disk, the rotatable disk being positionable in a selected plurality of angular orientations corresponding to the plurality of door thicknesses.

The rotatable disk is resiliently pivoted to the base so that it is perpendicularly retractable from and toward the base on its pivot and so that an end of the guide pin selectively extends into one of a plurality of bores defined into the base to define a corresponding position of the guide pin relative to the aperture of the end module.

The nail has a distal end, and further includes a compression spring, where the nail is retained in the base with the compression spring thereby positioning the nail in a configuration where the distal end of the nail is retained in the base, while allowing the nail to be driven against the compression spring to temporarily extend from the base and act as a temporary fastening of the module to the door or door jamb,

At least one of the connecting bars has a nail retained in the connecting bar for temporarily fixing the module to the door or door jamb.

The door has an edge in which the mortise is defined and further comprising a folding index disposed on an outer end of the end module to aid in alignment of the universal door hinge template assembly with the door edge.

The connecting bar is a shaped metal channel bar.

Each connecting bar is disposed in a mortise defined in the base of the module and selectively coupled into the mortise by a plurality of screws.

The illustrated embodiments also include a universal door hinge template assembly for use with a tool for fabricating a mortise in a door or door jamb for a hinge. The assembly includes a plurality of template modules including at least two end modules with one or more intermediate modules, where each template module comprises: a base having an aperture defined therein to guide the tool for forming the mortise, the aperture having two pairs of opposing sides; a pair of opposing adjustable hinge templates having a selected shape and selectively positioned at one of the pairs of opposing sides of the aperture; and a plurality of connecting bars of selective length which are selectively fixed between each two adjacent template modules in the assembly.

The universal door hinge template assembly further includes an adjustable door thickness guide.

The universal door hinge template assembly further includes means for temporarily fixing the module or connecting bar to the door or door jamb, which could include a nail, rivet, bolt, spike, clamp and any kind of fastening fitting or mechanism for temporarily fastening onto a door or door jamb.

Each the pair of hinge templates is reversible to provide a guide for two different shaped hinges.

An aperture mortise is defined around the aperture and the pair of reversible hinge templates are selectively fixed into the aperture mortise at one of a plurality of selected positions and form a selected guiding edge of the aperture.

The door has an edge in which the mortise is to be defined and further includes index means for aligning the universal door hinge template assembly lengthwise along the edge of the door. The index means is any kind of alignment mechanism or structural element which can be temporarily deployed and then withdrawn.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The disclosure can be better visualized by turning now to the following drawings wherein like elements are referenced by like numerals.

### BRIEF DESCRIPTION OF THE DRAWINGS

FIG. 1 is top plan view of the hinge template assembly in a configuration with four modules for fabricating four mortises.

FIG. 2 is a close up top perspective view of an end module and an intermediate module coupled by connecting bars.

FIG. 3 is a bottom perspective view of n end module and its adjacent connecting bar.

FIG. 4 is a top perspective view f an end module and its adjacent connecting bar.

FIG. 5 is a bottom plan view of the door thickness guide and index of an end module fully rotated into an operative configuration.

FIG. 6 is an end plan view of the index of the end module shown partially rotated toward an operative configuration.

FIG. 6a is a close up end view of FIG. 6 showing the index in a disassembled configuration.

FIG. 7 is a bottom perspective view of another embodiment where the rotatable guide is placed in the extension bar.

FIG. 7a is a bottom perspective view of FIG. 7 with the rotatable circular guide removed.

FIG. 8 is the top perspective view of the embodiment of FIG. 7 showing the knob used to rotate the guide.

FIG. 9 is a top perspective view a module used for the installation of an invisible Soss hinge.

FIG. 10 is a close-up perspective view of an interior edge of the mortise aperture showing how the pins used to define the deep mortise guide extend across the aperture and are locked into position by a resilient leaf spring.

FIG. 11 is the close-up view of FIG. 10 where the pin has been slightly withdrawn to show a cut-away notch in the pin for the disposition of the leaf spring and its locking of the pin.

FIG. 12 is an enlarged end view of the module showing a slidable end fitting used as a guide for the correct lateral position of the module.

FIG. 13 is an end view of the module showing a spring loaded sliding cover of an interior compartment defined in the module in which the pins are stored when not in use.

FIG. 14 is a bottom plan view of a module provided with storage recesses or a plurality of mortise templates of different sizes and shapes.

The disclosure and its various embodiments can now be better understood by turning to the following detailed description of the preferred embodiments which are presented as illustrated examples of the embodiments defined in the claims. It is expressly understood that the embodiments as defined by the claims may be broader than the illustrated embodiments described below.

### DETAILED DESCRIPTION OF THE PREFERRED EMBODIMENTS

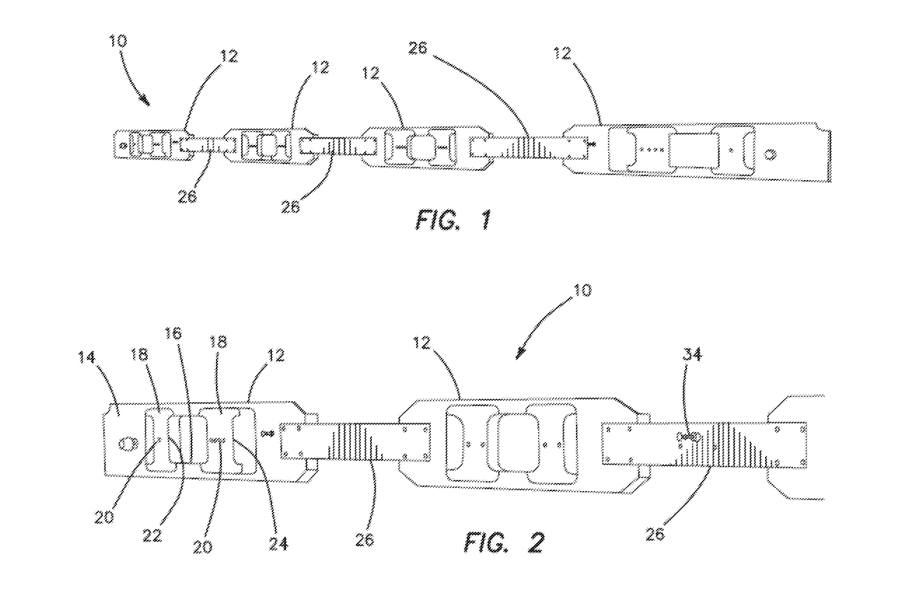

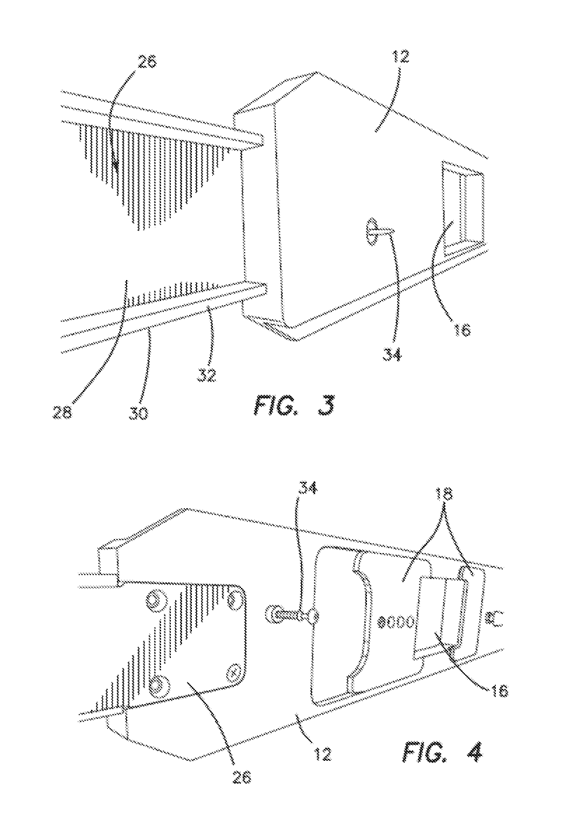

FIG. 1 is a top plan view of an assembled hinge template 10 comprised in the illustrated embodiment of four hinge modules 12, although any number of modules 12 may be combined. Modules 12 are coupled together by metal bars 26, which are screwed or bolted at their ends to module 12. In the illustrated embodiment bars 26 are bent channel bars having a primary surface 28 and integral side surfaces 30 with rounded edges 32 as best seen in the underside view of FIG. 3, while the ends of bars extend flatly over the adjacent module 12. The bars 26 are provided in different lengths according to the different hinge configurations and the door or jamb sizes which are to be fitted. Bars 26 of different lengths may be easily substituted for each other among modules 12,

Each module 12 includes a base 14 into which an aperture 16 is defined through which the routing tool extends to create the mortise for the hinge in the door or jamb. The opposing ends of aperture 16 is provided with a pair of corresponding selectively adjustable hinge templates 18. In the illustrated embodiment, base 14 is fabricated from high density finished plywood, while templates 18 are metal, but any type of tooling materials could be used, such a metal, plastic, wood or composite for both. In the illustrated embodiment, templates 18 have a series of one or more holes 20 defined therethrough template 18 may be fastened by a screw or bolt to base 14 to thereby adjust the distance of template 18 from its opposing template 18 on the opposing end of aperture 16. The edges 22 of template 18 adjacent aperture 16 are shaped to match the shaped edge of the corresponding hinge to be installed so that the mortise that is create snugly and tightly fits with the hinge. The opposing edge 24 is similarly shaped for a corresponding hinge, so that templates 18 can be simply rotated to bring either edge 22 or 24 adjacent aperture 16 depending on the shape or style of hinge being installed.

The end modules 12 as seen in FIG. 1 are different than those interior to the sequence of modules making up the assembled template 10. First end modules 12 include a spring loaded nail 34 best seen in FIG. 4. Nail 34 extends through base 14 as shown also in FIG. 3 and may be driven by hammering into the desired position in a door or jamb in order to fix hinge template assembly 10 in place while it the mortises are being routed. A similar spring loaded nail 34 is also provided in the middle bar 26 as best seen in FIG. 2 and provides a third point of affixation for hinge template assembly 10 along with nails 34 provided in each of the end modules 12. Nail 34 is spring loaded so that it is retained in a noninterfering position within module 12 as it is being positioned against the door or jam, but when the position is determined, nail 34 is driven into the door or jam to secure module 12 temporarily in place.

End modules 12 also include a door thickness guide 36 best seen in FIG. 5 which illustrates the bottom plan view of end module 12. Guide 36 is provided in the illustrated embodiment as a rotatable disk from which a vertically extending pin 38 is provided. Guide 36 is spring loaded and is lifted vertically from base 14 to remove an end of pin 38 from a bore (not shown) defined in base 14 underneath guide 36 to allow guide 36 to then be rotated. As guide 36 rotates about pivot pin 40, extending pin 38 is positioned in one of a plurality of selected locations offset a corresponding distance from the edge of module 12, which distance correspondences to one of a plurality of selected door thicknesses. A plurality of bores (not shown) are defined in base 14 to accept disposition therein of the opposing end of pin 38 according to the selected door thickness. The extending end of pin 38 then acts as a selectively positionable guide to position module 12 relative to the edge of the door against which side pine 38 is pressed.

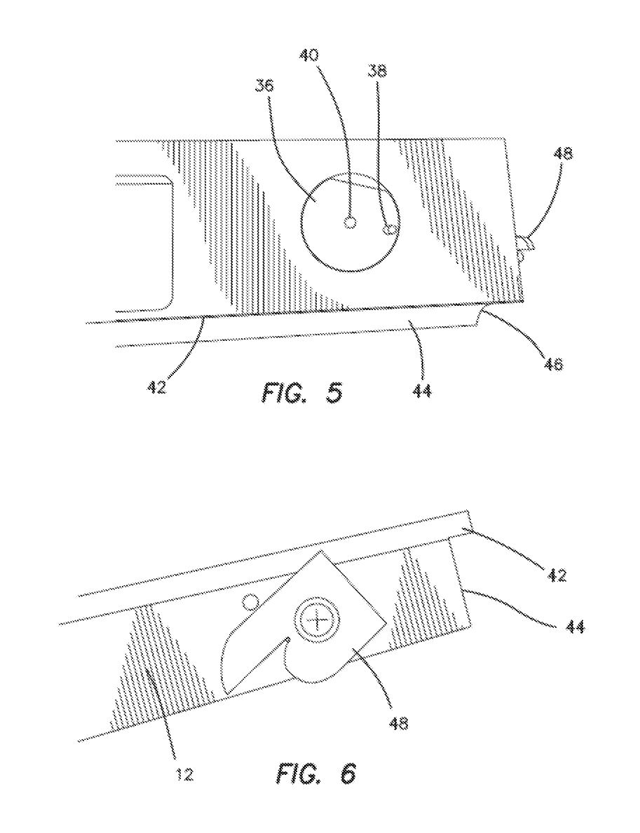

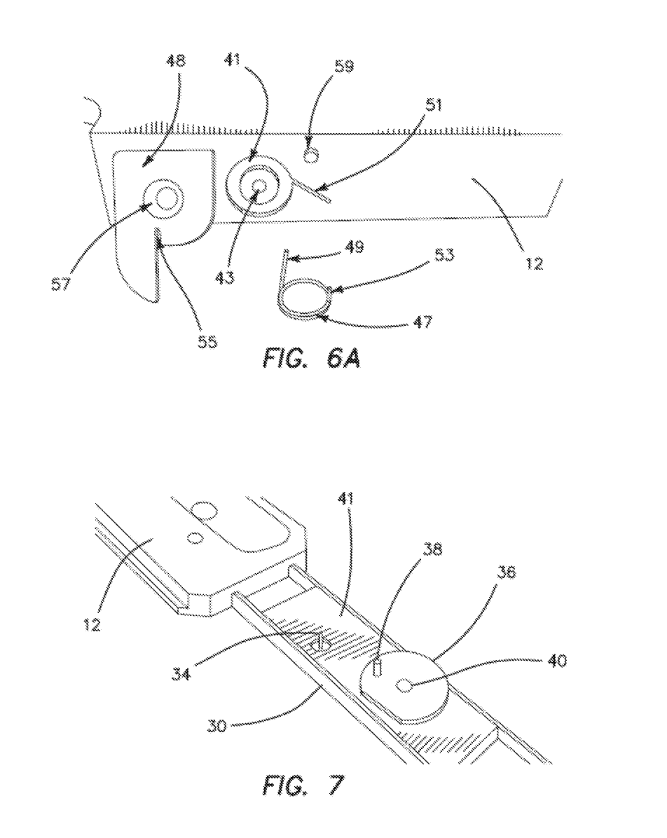

The hinge template 10 is placed flatly on the edge of the door and aligned against pin 38 in each of the end modules 12 set in a selected position for the desired door thickness. As a result the appropriate portion of the door's edge will be exposed or accessible through aperture 16 for routing out an appropriately sized and position mortise for the door which will be set into the edge of the door. A spring loaded rotatable index stop 48 is provided on the end edge of end module 12 to be aligned with the end edge of the door so that hinge template assembly 10 is properly registered lengthwise with the length of the door edge. Index stop 48 is better depicted in the view of FIG. 6 showing index stop 48 is a partially rotated position. Index stop 48 is rotated to extend above the top surface module 12 when index stop 48 is needed to serve as an alignment stop for a door, and then is rotated to be entirely adjacent to the end edge of module 12, when not needed. When module 12 is moved against the jam when forming a mortise for the door hinge, index stop 48 serves as a stop for the gap around the door, rotating by means of spring 47.

FIG. 6a provides an enlarged view and disassembled view of index stop 48, which is rotatably coupled to module 12 by a screw 45 shown in FIG. 6 (not shown in FIG. 6b) that is screwed into bore 43 through hole 57 defined in index stop 48. Spring 47 is placed into circular recess 41 with straight end 49 disposed into groove 51 defined into the edge of module 12. End 53 of spring 47 extends generally perpendicular to straight end 49 and extends into slot 55 defined in index stop 48. Pin 59 is disposed into the edge of module 12 and serves as a stop against the counterclockwise rotation of index stop 48 as seen in FIG. 6a when assembled and spring loaded.

Modules 12 have a thinned extending flange 42 extending from the abutting edge 44 of module 12 that is placed against the door stop strip in a door jamb. Flange 42 will extend over the adjacent door stop strip with edge 44 abutting the door stop strip so that the mortise aperture 16 is properly positioned for the mortise for hinge placement into the jamb. The end of flange 42 is cut away to leave a space 46 at the end of the end module 12 to provide clearance for an intersecting door stop strip across the top of the door jamb, where it meets the vertical side door stop strips on the sides of the door jamb.

The overall use of the hinge template assembly 10 may now be understood. First assume it is to be used to form mortises for a hinge in the edge of a door. The door is place on edge with the side of the door into which the mortises will be formed being uppermost. The assembly 10 comprised of the selected bars 26 connected modules 12 is then placed on top of the door edge. Index stop 48 is rotated out so that it abuts the top edge of the door and the assembly is thus correctly registered in position with respect to the top of the door. The guides 36 are set in the correct door thickness and pin 38 is pressed against the surface of the door so that apertures 16 expose the portions of the door edge in which the mortises are to be formed. Nails 34 are then pounded into the door edge to temporarily fix assembly to the door edge. A router is then used in apertures 16 to define the desired mortises.

Similarly, the mortises in the door jamb as formed by pressing edge 44 of assembly 10 against the door stop strip in the side of the jamb. Assembly 10 is pressed upwardly in the door jamb so that its upper end abuts the upper horizontal frame of the door jamb. Index stop 48 is rotated flush with the upper end of assembly 10 and is out of the way. Again nails 34 are then pounded into the door jamb to temporarily fix assembly 10 to the jamb. The apertures 16 will expose portions of the vertical side of the door jamb where the router ill be used to define the mortises. The mortises in the door jamb and door edge will precisely match and will also conform precisely to the outline of the hinge plate that will be inset into the receiving mortise.

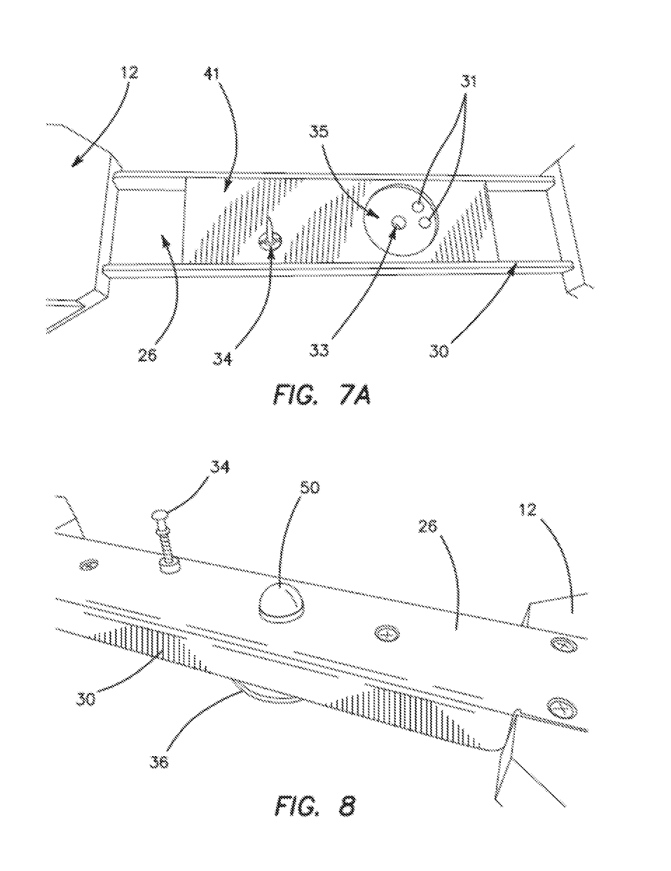

The embodiment of FIG. 7 shows the underside of an extension bar 26 between two modules 12 and illustrates that rotatable guide 36 carrying pin 38 for adjustment of the lateral positioning of template assembly 10 against the door or jam may be placed in bar 26 in a filler piece 41 compressed, screwed, fixed or adhered into the underside of the channel of bar 26. Captively retained nail 34, used to tack template assembly 10 in place on the door or am, may also be provided in bar 26 with rotatable guide 36, the lower portion of which is shown extending through bar 26 and filler piece 41. FIG. 7a illustrates the underside view of FIG. 7 with rotatable guide 36 removed. A recess 35 is defined in filler piece 41 into which guide 36 is disposed. A center bore 33 receives the lower extending portion of center rotation pin 40 seen in FIG. 7 of guide 36. The lower extending portion of positioning pin 38 of guide 36 is selectively disposable in either one of two index bores 31 shown in FIG. 7a according to the chosen spacing to be provided by the straight or flattened edge of circular guide 36. FIG. 8 is a perspective view of the upper side of bar 26 shown in FIG. 7 and illustrates captively held nail 34 and a spring loaded turning knob 50 used to rotate guide 36. Although not shown in FIG. 8, knob 50 fixed to the top of pin 40 and spring loaded using a compression spring so that guide 36 may be lift up and down within recess 35 in FIG. 7a to allow positioning pin 38 to be selectively disposed into and out of one of the index bores 31. The embodiment of FIGS. 7 and 8 may be employed in combination with the guides 12 and bars 26 provided for installation of Soss hinges as described below.

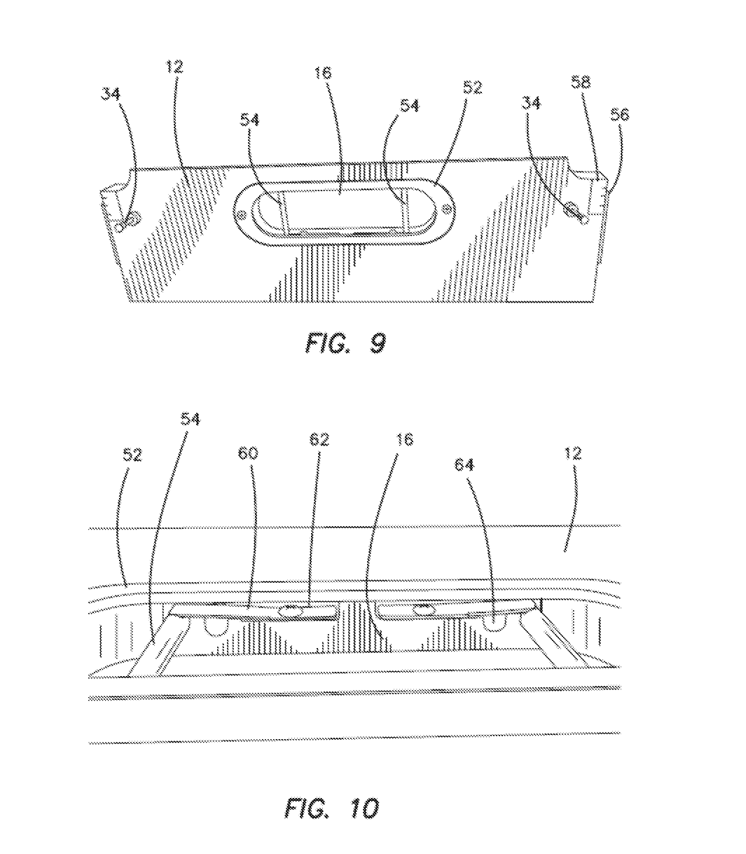

FIG. 9 is a top perspective view of a module 12 used for the installation of an invisible or Soss hinge. An invisible hinge is one in which the hinge mechanism is concealed within the door or jam when the door is closed. Soss is one company in Pioneer, Ohio, who is an established manufacturer of a particular line of invisible hinges, which have become known as Soss hinges. In the following, the term, “Soss hinge” may be used, but it is to be understood to include any kind of invisible hinge. In the case of a Soss hinge, a shallow and deep mortise must be formed. The shallow mortise accommodates the hinge flanges or plates and the deep mortise receives a multiplate hinge mechanism, which is disposed entirely into the mortise, thereby leaving no hinge pin or hinge portion exposed after the door closes on the jam. The mortise jig aperture 16 defined in module 12, shown in FIG. 9 with a reinforcing metal border 52, is provided with two positionable pins 54 extending across aperture 16. A router is first used set at a shallow setting within the space defined by aperture 16, when module 16 is correctly positioned and tacked into place using captured nails 34. An end fitting 56 and indicia card 58 as shown in better detail in FIG. 12 is used to as described above to laterally position module 12 at the correct position on the door or jam. Pins 54 are then inserted across aperture 16 in a selected one of multiple receiving holes described below according to the size of the Sass hinge being used. The router is contained in the space within aperture 16 and between pins 54 for guiding the router when the deep mortise is defined in the door or jam.

FIG. 10 is a close-up perspective view of a slot 62 defined in an interior edge of the mortise aperture 16 showing how the pins used to define the deep mortise guide extend across the aperture 16 and are locked into position by a resilient leaf spring 60. In the illustrated embodiment there are two possible receiving holes 64 for each pin 54. FIG. 10 shows the outer pair being used for disposition of pins 54 therein. A second pair of holes 64 are defined into slot 62 allowing pins 54 to be more closely disposed to each other across aperture 16 to define the deep mortise aperture for a smaller Sass hinge. A multiple number of such pairs of holes 64 could be provided, each pair for a different size of Soss hinge.

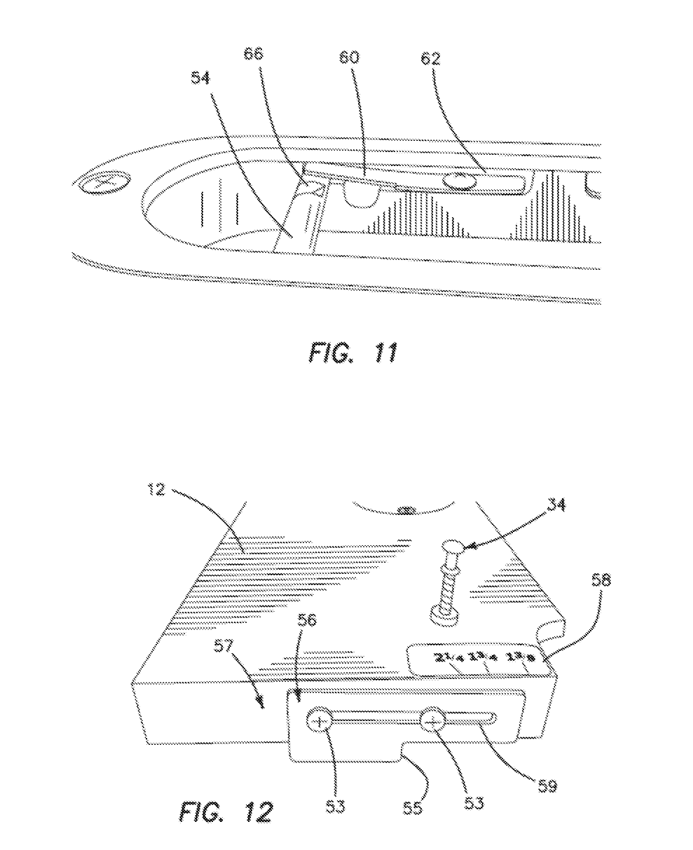

FIG. 11 is the close-up view of FIG. 10 where the pin 54 has been slightly withdrawn from slot 62 to show a cut-away notch 66 in the pin 54 for the disposition of the leaf spring 60 in notch 66 when pin 54 is fully disposed into slot 62 thereby locking pin 54 in position across aperture 16.

FIG. 12 is an enlarged end view of the module 12 showing a slidable end fitting 56 used as a guide for the correct lateral position of the module 12. Fitting 56 is formed in the shape of an “L” with a stop 55 for use against the jams and door edges. Fitting 56 retained on module 12 by screws 53 which are fixed into module 12 through slot 59 defined in fitting 56. Spring loaded capture nail 34 is clearly shown on the upper surface of module 12 near indicia card 58 in FIG. 12. A portion of fitting 56 extends beyond the bottom surface of module 12, so that when module 12 is laid against the door edge or jam, its lateral position relative to the door or jam thickness can be adjusted by positioning and tightening fitting 56 with the extended portion of the stop 55 abutting the door or jam in one of the multiple positions marked on indicia card 58 positioned on the top adjacent surface of module 12 as shown in FIG. 9. Pin 57 is fixed into the edge of module 12 and serves as a stop against which fitting 56 is pressed, when fitting 56 is positioned for a 2¼ inch thick door. Screws 23 are selectively positioned so that when fitting 56 is positioned so that left end of slot 59 bears against left screw 23 in FIG. 12, fitting 56 is positioned appropriately for a 1⅜ inch thick door. When fitting 56 is positioned so that the right screw 23 in FIG. 12 is positioned against the right end of slot 59 in FIG. 12, fitting 56 is positioned appropriately for a 1¾ inch thick door.

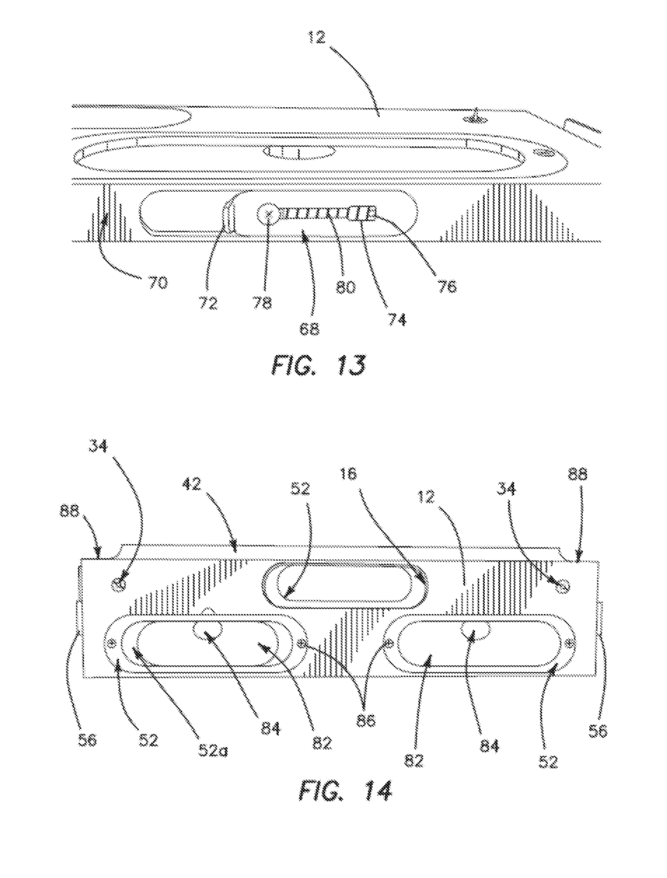

Finally, FIG. 13 is a side plan view of the module 12 showing a spring loaded sliding cover 68 of an interior compartment (not shown) defined in the module 12 in which the pins 54 are stored when not in use. The compartment is defined in module 12. Cover 68 is retained and guided in a recess 70 defined in the edge of module 12 and manipulated manually using a extending tab 72. Cover 68 is retained on module 12 by a screw 78, which bears against a compression spring 74 fixed on its opposing end 76 to cover 68 and which screw 78 guides cover 68 by means of slot 89 defined in cover 68. Multiple pins 54 may be placed in the compartment and the cover 68 allowed to snap closed over the opening to the compartment thereby retaining the pins 54 therein until they are needed.

As shown in FIG. 13 the underside of module 12 may be fitted with a recess 82 into which one or more mortise templates 52 can be disposed and stored. For example the left recess 82 in FIG. 14 shows a template 52 and 52a stored in the same recess 82. A fingerhole 84 is also defined in the underside of module 12 to assist in the ease whereby templates 52, 52a, once their retaining. screws 86 have been removed, may then be removed from a close fitting recess 82. Cutaway corners 88 are removed from ends of the edge flange 42 as best seen in FIG. 14 to accommodate the door stop edges in the jam.

Many alterations and modifications may be made by those having ordinary skill in the art without departing from the spirit and scope of the embodiments. Therefore, it must be understood that the illustrated embodiment has been set forth only for the purposes of example and that it should not be taken as limiting the embodiments as defined by the following embodiments and its various embodiments.

Therefore, it must be understood that the illustrated embodiment has been set forth only for the purposes of example and that it should not be taken as limiting the embodiments as defined by the following claims. For example, notwithstanding the fact that the elements of a claim are set forth below in a certain combination, it must be expressly understood that the embodiments includes other combinations of fewer, more or different elements, which are disclosed in above even when not initially claimed in such combinations A teaching that two elements are combined in a claimed combination is further o be understood as also allowing for a claimed combination in which the two elements are not combined with each other, but may be used alone or combined in other combinations. The excision of any disclosed element of the embodiments is explicitly contemplated as within the scope of the embodiments.

The words used in this specification to describe the various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the embodiments.

We claim:

1. A kit for a universal door hinge template assembly for use with a tool for fabricating a mortise in a door or door jamb for a hinge comprising:
a plurality of template modules including at least two end modules with possibly one or more included intermediate modules,
where each template module comprises:
a base having an aperture defined therein to guide the tool for forming the mortise, the aperture having two pairs of opposing sides;
a pair of opposing adjustable hinge templates having a selected shape and selectively positioned at one of the pairs of opposing sides of the aperture;
where the end modules comprise an adjustable door thickness guide and a nail retained in the base for temporarily fixing the module to the door or door jamb; and
a plurality of connecting bars of selective length which are selectively fixed between each two adjacent template modules in the assembly.

2. The kit of claim 1 where the plurality of connecting bars are providing with varying lengths to allow user selection in configuring the universal door hinge template assembly to be usable with a plurality of door and door jamb sizes and number of hinges to be fitted therein.

3. The kit of claim 1 where each the pair of hinge templates is reversible to provide a guide for two different shaped hinges.

4. The kit of claim 1 where a plurality of hinge templates are provided each with a guide corresponding to a plurality of different hinge shapes.

5. The kit of claim 1 where the door has an edge into which the mortise is defined and where the adjustable door thickness guide comprises a selectively positionable guide pin corresponding to a plurality of door thicknesses, the guide pin for positioning the end module and its corresponding aperture relative to the door edge.

6. The kit of claim 5 where the adjustable door thickness guide further comprises a rotatable disk pivoted to the base of the end module and where the guide pin is coupled to the rotatable disk, the rotatable disk being positionable in a selected plurality of angular orientations corresponding to the plurality of door thicknesses.

7. The kit of claim 6 where the rotatable disk is resiliently pivoted to the base so that it is perpendicularly retractable from and toward the base on its pivot and so that an end of the guide pin selectively extends into one of a plurality of bores defined into the base to define a corresponding position of the guide pin relative to the aperture of the end module.

8. The kit of claim 1 where the nail has a distal end, and further comprising a compression spring, where the nail is retained in the base with the compression spring thereby positioning the nail in a configuration where the distal end of the nail is retained in the base, while allowing the nail to be driven against the compression spring to temporarily extend from the base and act as a temporary fastening of the module to the door or door jamb.

9. The kit of claim 1 at least one of the connecting bars has a nail retained in the connecting bar for temporarily fixing the module to the door or door jamb.

10. The kit of claim 1 where the door has an edge in which the mortise is defined and further comprising a folding index disposed on an outer end of the end module to aid in alignment of the universal door hinge template assembly with the door edge.

11. The kit of claim 1 where the connecting bar is a shaped metal channel bar.

12. The kit of claim 1 where each connecting bar is disposed in a mortise defined in the base of the module and selectively coupled into the mortise by a plurality of screws.

13. A universal door hinge template assembly for use with a tool for fabricating a mortise in a door or door jamb for a hinge comprising:
a plurality of template modules including at least two end modules with one or more intermediate modules,
where each template module comprises:
a base having an aperture defined therein to guide the tool for forming the mortise, the aperture having two pairs of opposing sides;
a pair of opposing adjustable hinge templates having a selected shape and selectively positioned at one of the pairs of opposing sides of the aperture; and
a plurality of connecting bars of selective length which are selectively fixed between each two adjacent template modules in the assembly.

14. The universal door hinge template assembly of claim 13 further comprising an adjustable door thickness guide,

15. The universal door hinge template assembly of claim 13 further comprising means for temporarily fixing the module or connecting bar to the door or door jamb.

16. The universal door hinge template assembly of claim 13 where each the pair of hinge templates is reversible to provide a guide for two different shaped hinges.

17. The universal door hinge template assembly of claim 16 where an aperture mortise is defined around the aperture and where the pair of reversible hinge templates are selectively fixed into the aperture mortise at one of a plurality of selected positions and form a selected guiding edge of the aperture.

18. The universal door hinge template assembly of claim 13 where the door has an edge in which the mortise is to be defined and further comprising index means for aligning the universal door hinge template assembly lengthwise along the edge of the door.

19. A universal door hinge template for use with a tool for fabricating a composite mortise in a door or door jamb for any one of a plurality of sizes of invisible hinges comprising:
a base with an aperture defined therein to guide the tool for forming the mortise, the aperture having two pairs of opposing sides and an interior edge, the interior edge of the aperture for providing a guiding surface for a first mortise of a first depth; and
a pair of guide pins selectively disposed across the aperture through or into selected ones of a plurality of holes defined in the interior edge of the aperture, the pair of pins in combination with the interior edge of the aperture between the pins for providing a guiding surface for a second mortise of a second depth deeper than the first depth of the first mortise, the second mortise for receiving the invisible hinge, the selected ones of the plurality of holes being selected according to the size of the invisible hinge to be accommodated within the second mortise.

20. The universal door hinge template of claim 19 further comprising a resilient locking spring for engaging each one of the pair of pins to selectively lock them into position across the aperture into the selected ones of a plurality of holes defined in the interior edge of the aperture.
